(19) United States
(12) Patent Application Publication
(10) Pub. No.: US 2014/0136272 A1
(43) Pub. Date: May 15, 2014

(54) SYSTEM AND METHOD FOR PROVIDING GANTT-TREND CHART IN A SUPPLY CHAIN MANAGEMENT ENVIRONMENT

(71) Applicant: M3 TECHNOLOGY, INC., Houston, TX (US)

(72) Inventors: Dong Dong, Sugar Land, TX (US); Larry Pan, Sugar Land, TX (US); David Jasper, Houston, TX (US)

(73) Assignee: M3 TECHNOLOGY, INC., Houston, TX (US)

(21) Appl. No.: 13/677,162

(22) Filed: Nov. 14, 2012

(51) Int. Cl. G06Q 10/06

(52) U.S. Cl. CPC G06Q 10/06315
USPC 705/7.25

(57) ABSTRACT

A system and method support a supply chain management platform for a supply chain management environment. The supply chain management platform can provide a graphical representation of one or more material inventory trends in the supply chain management environment. Additionally, the supply chain management platform can using one or more tokens to display one or more activities on the graphical representation of the one or more material inventory trends, wherein the one or more activities contribute to inventory change in the supply chain management environment. Furthermore, the supply chain management platform allows a user to perform one or more supply chain scheduling operations in the supply chain management environment based on the graphical representation.

### FIELD OF THE INVENTION

This invention relates generally to supply chain management, and relates more particularly to supporting charting in a supply chain management environment.

### BACKGROUND

A supply chain describes the movement and storage of raw materials, work-in-process inventory, and finished goods from point of origin to point of consumption. A supply chain management environment can manage interconnected businesses and/or facilities involved in the provision of product and service packages in the supply chain. This is the general area that embodiments of the invention are intended to address.

### SUMMARY

Described herein are systems and methods that can support a supply chain management platform for a supply chain management environment. The supply chain management platform can provide a graphical representation of one or more material inventory trends in the supply chain management environment. Additionally, the supply chain management platform can using one or more tokens on the graphical representation of the one or more material inventory trends to display one or more activities, wherein the one or more activities contribute to inventory change in the supply chain management environment. Furthermore, the supply chain management platform allows a user to perform one or more supply chain scheduling operations in the supply chain management environment based on the graphical representation.

### BRIEF DESCRIPTION OF THE DRAWINGS

FIG. 1 is an exemplary illustration of supporting charting in a supply chain management environment, in accordance with various embodiments of the invention.

FIG. 2 is an exemplary illustration of a flow diagram for supporting charting in a supply chain management environment, in accordance with various embodiments of the invention.

FIG. 3 is an exemplary illustration of a GT-View, in accordance with various embodiments of the invention.

FIG. 4 is an exemplary illustration of multiple GT-Charts displayed in a GT-View, in accordance with various embodiments of the invention.

FIG. 5 is an exemplary illustration of a full-size GT-Chart, in accordance with various embodiments of the invention.

FIG. 6 is an exemplary illustration of using transient bar and curve to facilitate supply chain scheduling activities, in accordance with various embodiments of the invention.

FIG. 7 is an exemplary illustration of a GT-View that only displays the GT-Charts with inventory violations, in accordance with various embodiments of the invention.

FIG. 8 is an exemplary illustration of a GT-View that shows activity details, in accordance with various embodiments of the invention.

### DETAILED DESCRIPTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

Supply chain management software, e.g. Planning Workspace Pro (PW Pro™), can provide a supply chain management platform for handling a wide range of supply chain activities and providing supply chain visibility. Furthermore, the supply chain management platform can be used for managing inventory, generating enterprise reports, and delivering real business intelligence.

In accordance with various embodiments of the invention, a supply chain management platform can provide various charting tools for supporting supply chain management.

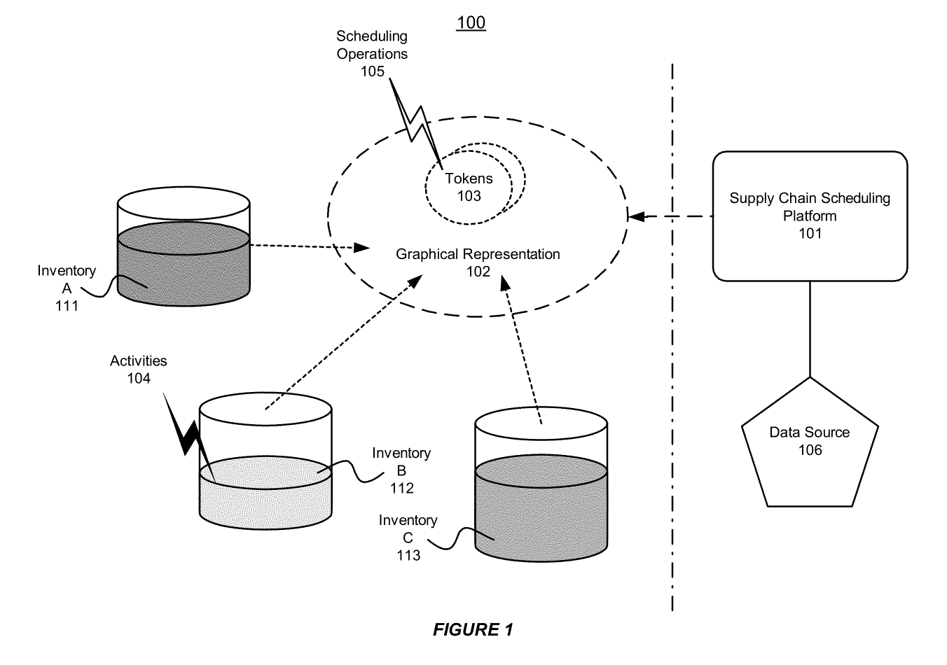

FIG. 1 is an exemplary illustration of supporting charting in a supply chain management environment, in accordance with various embodiments of the invention. As shown in FIG. 1, a supply chain management environment 100 can manage one or more inventories, e.g. inventories A-C 111-113, in different types and/or at different locations.

A supply chain management platform 101 can provide a graphical representation 102 of the material inventory trends for the different inventories A-C 111-113. Also, the graphical representation 102 can include one or more tokens 103 for displaying one or more activities 104 that contribute to inventory change in the supply chain management environment 100.

Furthermore, a user can perform one or more supply chain scheduling operations 105 based on the graphical representation 102 provided in the supply chain management environment 100. For example, a user can reschedule one or more activities 104 in the supply chain management environment 100 via manipulating the one or more tokens 103 on the graphical representation 102.

In accordance with various embodiments of the invention, the supply chain management platform 102 can rely on one or more data sources 106 for collecting and maintaining information on the different inventories A-C 111-113, at different locations. Additionally, the supply chain management platform 102 can display the graphical representation 102 either in a standalone application or on a web browser that can run on a general purpose computing device such as a computer or a mobile device.

For example, the PW Pro′ can provide a Gantt-Trend view (or a GT-View) that includes one or more Gantt-Trend charts (or GT-Charts), each of which can be a combination of a Gantt chart and a trend chart.

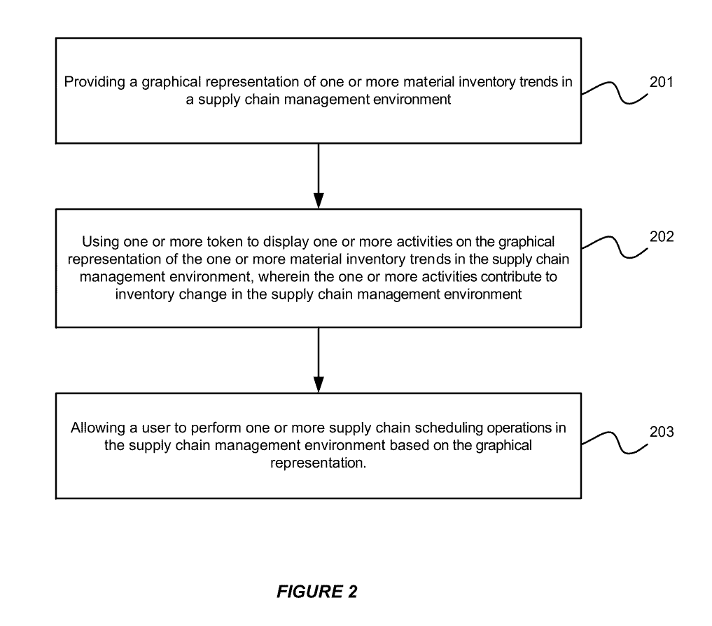

FIG. 2 is an exemplary illustration of a flow diagram for supporting charting in a supply chain management environment, in accordance with various embodiments of the invention. As shown in FIG. 2, at step 201, the supply chain management platform can provide a graphical representation of one or more material inventory trends in a supply chain management environment. Then, at step 202, the supply chain management platform can use one or more tokens to display one or more activities on the graphical representation of the one or more material inventory trends in the supply chain management environment, wherein the one or more activities contribute to inventory change in the supply chain management environment. Furthermore, at step 203, the supply chain management platform allows a user to perform one or more supply chain scheduling operations in the supply chain management environment based on the graphical representation.

### GT-View

In accordance with various embodiments of the invention, a GT-view provides a convenient platform for supply-chain scheduling.

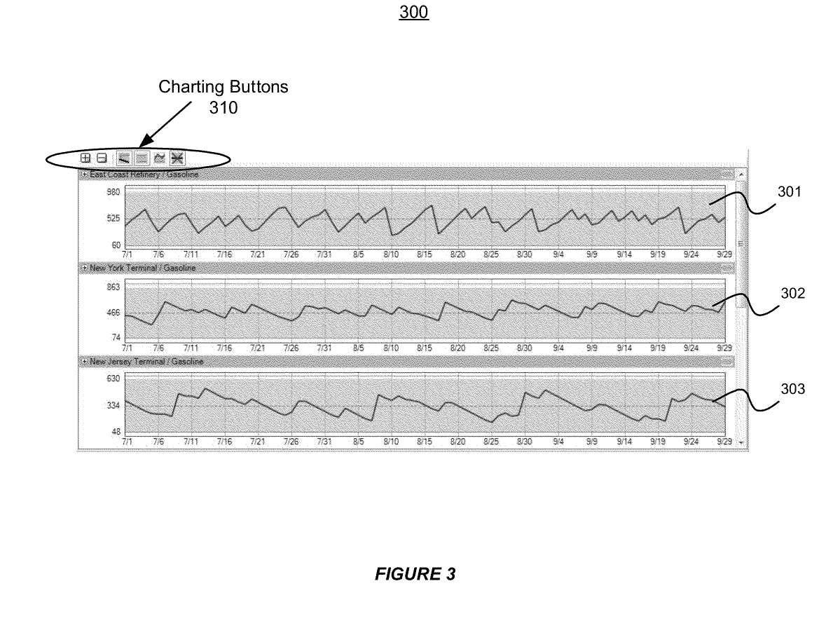

FIG. 3 is an exemplary illustration of multiple GT-charts displayed in a GT-View, in accordance with various embodiments of the invention. As shown in FIG. 3, a GT-view 300 can include several GT-Charts 301-303 that indicate the gasoline inventories at three different refineries: GT-Chart 301 shows the gasoline inventory for “East Coast Refinery/RBOB Regular,” GT-Chart 302 shows the gasoline inventory for “New York Terminal/CBOB Regular,” and GT-Chart 303 shows the gasoline inventory for “New York Terminal/CBOB premium.”

Additionally, the GT-View 300 can use various filters for display information at different detail levels and manipulating the display. The filters can be linked to one or more designated charting buttons 310 that are provided for the GT-View 300. For example, the GT-View 300 can include, but not limit to, a button to show or hide activity bars, a button to show or hide inventory limits, a button to show only the charts that have inventory limit violations, and a button to show or hide constant inventory chart.

### GT-Chart

In accordance with various embodiments of the invention, a GT-View can include a collection of one or more GT-charts. Each GT-Chart can provide a graphical representation of material inventory trends and the activities (or events) that contribute to the inventory changes across different supply chain locations.

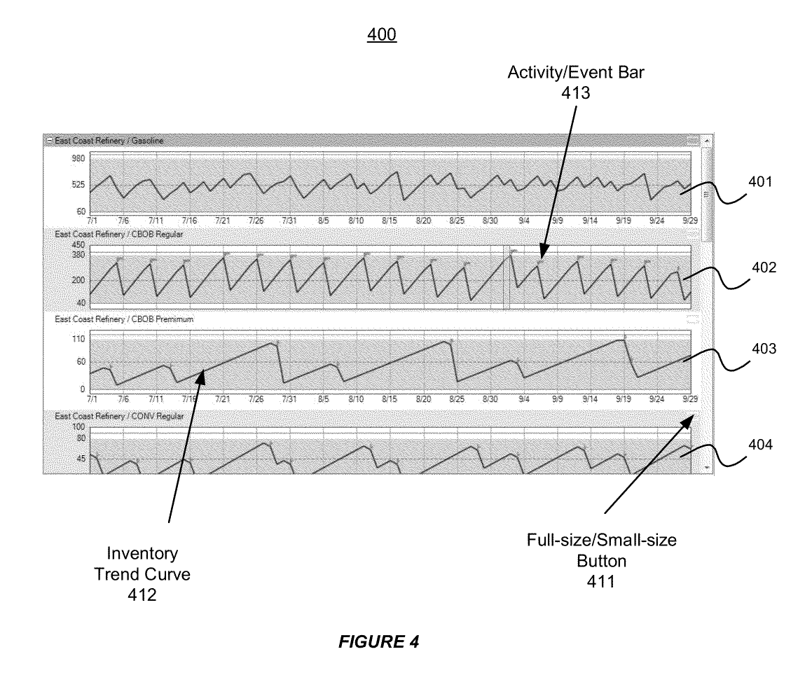

FIG. 4 is an exemplary illustration of multiple GT-charts displayed in a GT-View, in accordance with various embodiments of the invention. As shown in FIG. 4, a GT-View 400 can include several GT-Charts 401-404. The GT-Charts 401-404 can show the inventories of total gasoline and inventories of gasoline of different grades at the East Coast Refinery.

Each GT-Chart 401-404 can use one or more curves to represent different material inventory trend. For example, an inventory trend curve 412 can be used to display the “East Coast Refinery/CBOB premium” inventory. Additionally, each GT-Chart 401-404 can use one or more bars to represent different activities that can cause inventory change in the supply chain management environment. For example, an activity/event bar 413 can represent an activity that affect the “East Coast Refinery/CBOB Regular” inventory. Furthermore, the bars can be shown in different colors in order to distinguish activities in different activity categories.

Thus, by tightly coupling the material trends and material activities, the GT-view 400 can provide a visualization of the relationship between the material inventories and their related activities.

Additionally, the GT-View 400 can use a full-size/small-size button 411 to organize the graphical representation of the one or more material inventory trends, e.g. via material curve charts, in a master-slave relationship. By toggling the full-size/small-size button 411, the GT-View 400 allows a user to select between a full-size display, which shows more details, and a multi-chart display, which gives an overview.

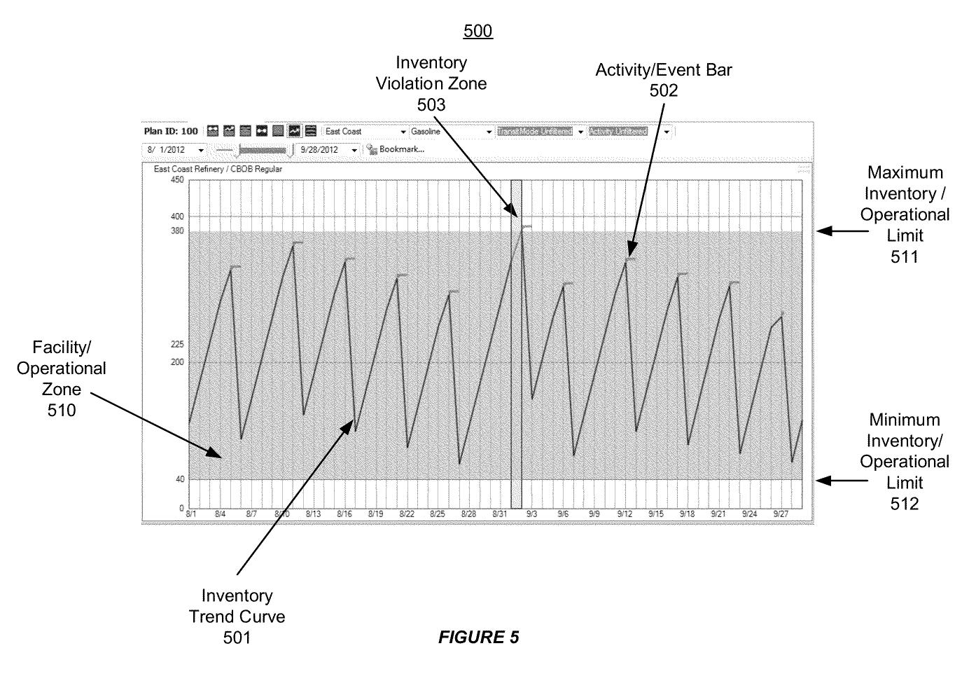

FIG. 5 is an exemplary illustration of a full-size GT-Chart, in accordance with various embodiments of the invention. As shown in FIG. 5, the full-size GT-Chart 500 can display a curve, or an inventory trend curve 501, overlaid on a facility/operational zone 510. The facility/operational zone 510 can be defined between a maximum limit 511 and a minimum limit 512 using a customizable color.

Furthermore, the supply chain scheduling platform can show an inventory violation warning zone 503 with a customizable background color on the graphical representation in GT-Chart 500, when the inventory trend ran out of the facility/operational zone 510. For example, the inventory violation warning zone 503 indicates that the inventory of “East Coast Refinery/CBOB Regular” exceeds the maximum inventory/operational limit 511 between “9/1 and 9/2.”

### Facilitate Supply Chain Scheduling Activities

In accordance with various embodiments of the invention, the supply chain scheduling platform allows the user to perform scheduling operations.

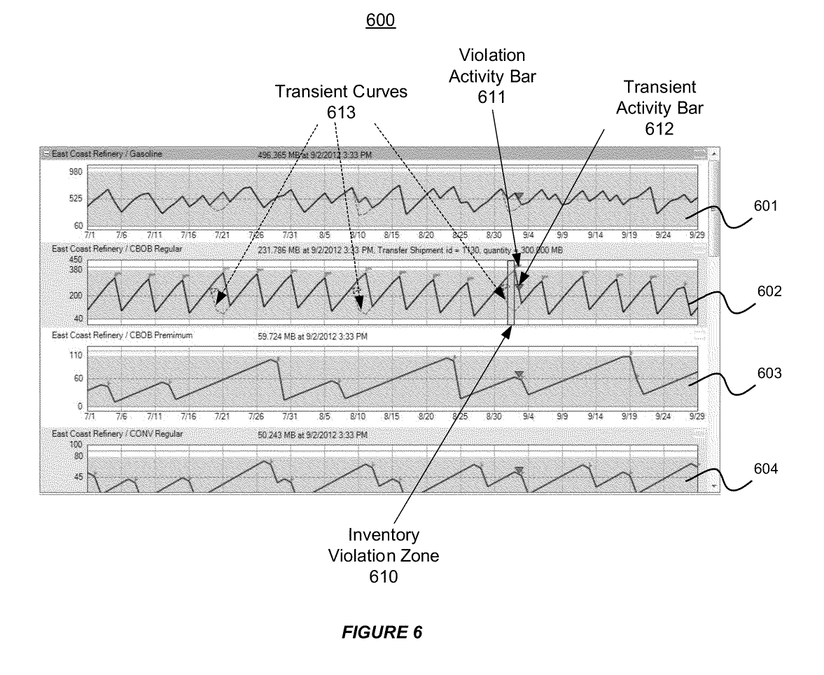

FIG. 6 is an exemplary illustration of using transient bar and curve to facilitate supply chain scheduling activities, in accordance with various embodiments of the invention. As shown in FIG. 6, a GT-View 600 includes several GT-Charts 601-604, with an inventory violation zone 610 displayed on the GT-Chart 602.

The supply chain scheduling platform allows a user to resolve the inventory violation 610, by moving an activity bar 611 that represents an activity that contributes to the inventory violation 610. As user moving the activity bar 611, the GT-chart 602 can display a transient bar 612 and transient curves 613 in order to provide visualization of the instantaneous inventory changes corresponding to the activity change accordingly to the moving of the activity bar.

Furthermore as shown in FIG. 6, as the user moves the activity bar 611 on the GT-Chart 602 for “East Coast Refinery/CBOB Regular” in the GT-View 600, the corresponding activity bars on the other GT-Charts 601 and 603-604 can all move accordingly. Also, the transient curves can be displayed on other GT-Charts 601 and 603-604 and allow the user to visualize the impact of the activity change on different inventories instantaneously.

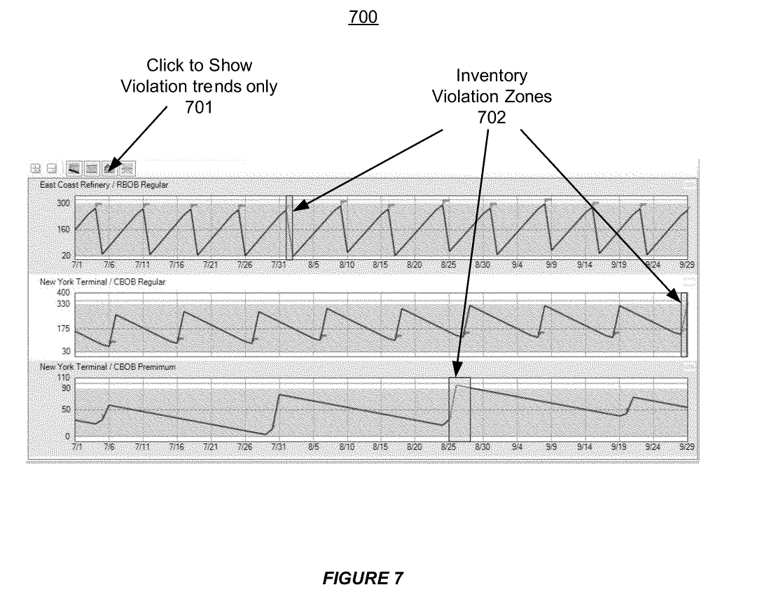

FIG. 7 is an exemplary illustration of a GT-view that only displays the GT-Charts with inventory violations, in accordance with various embodiments of the invention. As shown in FIG. 7, the GT-view 700 can associate a filter with a button 701. When a user clicks on the button 701, the GT-view 700 can display only the GT-Charts with inventory violations 702. This feature can help the user quickly finding out the inventory issues in the schedule.

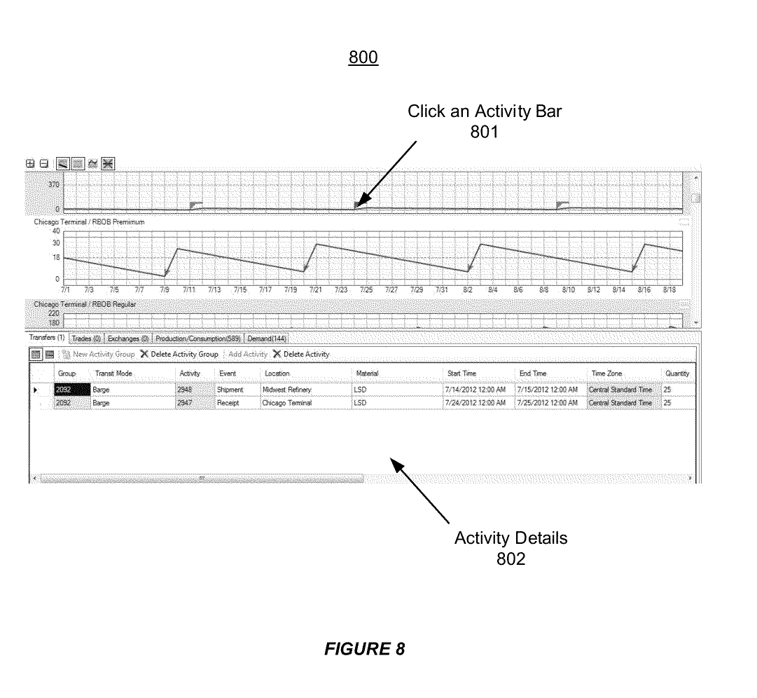

FIG. 8 is an exemplary illustration of a GT-view that shows activity details, in accordance with various embodiments of the invention. As shown in FIG. 8, when a user click on an activity bar 801, the GT-View 800 can display activity details 802 for an activity represented by the activity bar 801. Such activity details 802 can include a group number, transit mode, activity number, event type, location, material, and quantity and time duration information.

The present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media), the present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The forgoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

1. A computer-implemented method to support supply chain management, comprising:
providing a graphical representation of one or more material inventory trends in a supply chain management environment, wherein the graphical representation includes one or more curves;
using one or more bars on the one or more curves to display one or more activities in the supply chain management environment, wherein an beginning of a said bar indicates a starting time of an activity and an ending of a said bar indicates an ending time of an activity;
determining, via one or more microprocessors, inventory changes in each said material inventory trend in the supply chain management environment, when a user moves said one or more bars; and
displaying at least one transient bar and one or more transient curves on said one or more curves to provide visualization of the determined inventory change for each said material inventory trend in the supply chain management environment corresponding to a moving of said one or more bars by a user.

2. The computer-implemented method according to claim 1, further comprising:
allowing a user to perform one or more supply chain scheduling operations in the supply chain management environment based on the graphical representation.

3. The computer-implemented method according to claim 1, further comprising:
providing one or more filters that operate to display information at different detail levels.

4. The computer-implemented method according to claim 1, further comprising:
using a curve to represent each of said material inventory trends in the supply chain management environment.

5. The computer-implemented method according to claim 4, further comprising:
providing at least one inventory violation warning on the graphical representation.

6. (canceled)

7. The computer-implemented method according to claim 1, further comprising:
distinguishing different activity categories for the one or more activities.

8. The computer-implemented method according to claim 1, further comprising:
allowing the user to move said one or more bars on the graphical representation to facilitate scheduling activities.

9. (canceled)

10. The computer-implemented method according to claim 1, further comprising:
using a full-size/small-size button to select between a full-size display and a small size display.

11. A system to support supply chain management, comprising:
one or more microprocessors;
a supply chain management platform running on the one or more microprocessors, wherein the supply chain management platform operates to perform the steps of:
providing a graphical representation of one or more material inventory trends in the supply chain management environment, wherein the graphical representation includes one or more curves;
using one or more bars on the one or more curves to display one or more activities in the supply chain management environment, wherein an beginning of a said bar indicates a starting time of an activity and an ending of a said bar indicates an ending time of an activity;
determining, via one or more microprocessors, inventory changes in each said material inventory trend in the supply chain management environment, when a user moves said one or more bars; and
displaying at least one transient bar and one or more transient curves on said one or more curves to provide visualization of the determined inventory change for each said material inventory trend in the supply chain management environment corresponding to a moving of said one or more bars by a user.

12. The system according to claim 11, wherein:
a user can perform one or more supply chain scheduling operations in the supply chain management environment based on the graphical representation.

13. The system according to claim 11, wherein:
the supply chain scheduling platform operates to provide one or more filters that operate to display information at different detail levels.

14. The system according to claim 11, wherein:
the supply chain scheduling platform operates to use a curve to represent each of said material inventory trends in the supply chain management environment.

15. The system according to claim 14, wherein:
the supply chain scheduling platform operates to provide at least one inventory violation warning on the graphical representation.

16. (canceled)

17. The system according to claim 11, wherein:
the supply chain scheduling platform operates to distinguish different activity categories for the one or more activities.

18. The system according to claim 11, wherein:
the supply chain scheduling platform allows the user to move said one or more bars on the graphical representation to facilitate scheduling activities.

19. (canceled)

20. A non-transitory machine readable medium having instructions stored thereon that when executed cause a system to:
providing a graphical representation of one or more material inventory trends in a supply chain management environment, wherein the graphical representation includes one or more curves;
using one or more bars on the one or more curves to display one or more activities in the supply chain management environment, wherein an beginning of a said bar indicates a starting time of an activity and an ending of a said bar indicates an ending time of an activity;
determining, via one or more microprocessors, inventory changes in each said material inventory trend in the supply chain management environment, when a user moves said one or more bars; and
displaying at least one transient bar and one or more transient curves on said one or more curves to provide visualization of the determined inventory change for each said material inventory trend in the supply chain management environment corresponding to a moving of said one or more bars by a user.

21. The computer-implemented method according to claim 1, further comprising:
allowing a user to resolve an inventory violation by moving a said bar that represents an activity that contributes to the inventory violation.

22. The computer-implemented method according to claim 21, further comprising:
displaying an inventory violation zone on said one or more curves to indicate the inventory violation; and
removing the inventory violation zone from said one or more curves when the inventory violation is resolved.

23. The computer-implemented method according to claim 1, further comprising:
refreshing each said material inventory trend in the supply chain management environment, when a user moves said one or more bars.
